(19) United States
(12) Patent Application Publication
(10) Pub. No.: US 2026/0016598 A1
(43) Pub. Date: Jan. 15, 2026

(54) System for Recognizing Objects for a Vehicle

(71) Applicant: AUMOVIO Autonomous Mobility Germany GmbH, Ingolstadt (DE)

(72) Inventors: Matthias Strauß, Pfungstadt (DE); Ralph Grewe, Modautal (DE); Stephan Kirstein, Rodgau (DE); Andreas Hartmannsgruber, Singapore (SG)

(73) Assignee: AUMOVIO Autonomous Mobility Germany GmbH, Ingolstadt (DE)

(21) Appl. No.: 19/254,307

(22) Filed: Jun. 30, 2025

(30) Foreign Application Priority Data
Jul. 10, 2024 (DE) 102024206512.9

(51) Int. Cl. G01S 17/42; G01S 7/484; G01S 17/86; G01S 17/931

(52) U.S. Cl. CPC G01S 17/42; G01S 7/484; G01S 17/86; G01S 17/931

(57) ABSTRACT

A system for object detection for a vehicle, having a LIDAR module including a light source emitting light pulses, an optical matrix directing the emitted light pulses in accordance with a first scanning pattern illuminating a first field of view of the LIDAR module at a first scanning speed, and a receiver configured detecting the emitted light pulses scattered by one or more distant objects in order to record a first image using the first scanning pattern. The system further includes a camera module which records a second image of a second field of view at a second scanning speed. The second field of view at least partially overlaps the first field of view. The system further includes a controller which is signal-coupled to the camera module and the LIDAR module. The controller is configured to adapt the scanning pattern to synchronize the scanning patterns with one another in time.

### CROSS REFERENCE TO RELATED APPLICATIONS

This application claims priority to German Application No. 102024206512.9, filed Jul. 10, 2024, the contents of such application being incorporated by reference herein.

### FIELD OF THE INVENTION

The present disclosure relates to a system for recognizing objects for a vehicle. In addition, the present disclosure relates to a vehicle comprising a system for recognizing objects.

### BACKGROUND OF THE INVENTION

Driver assistance systems are technologies which have been developed in order to increase vehicle safety and to improve the general driving experience. These systems utilize sensors and cameras in order to monitor the surroundings and to support the driver in various ways.

It is desirable to indicate a system for recognizing objects for a vehicle which reliably recognizes the surroundings.

### SUMMARY OF THE INVENTION

Embodiments of the present disclosure relate to a system for recognizing objects for a vehicle and a vehicle which comprises said system.

The system for recognizing objects comprises a LIDAR module, also referred to as a LIDAR sensor. LIDAR (Light Detection and Ranging) is a form of three-dimensional laser scanning. LIDAR is used to optically measure distance and speed. LIDAR systems are utilized in the field of driver assistance systems for automobiles and automated driving. LIDAR is used in driverless transport vehicles, for example, for recognizing obstacles. The used systems are, for example, embodied as compact sensor modules. In the case of one possible design, the laser beam is, for example, deflected horizontally over a broad angular region, for example, up to 360°. In the vertical direction, a few angles are realized channel by channel, for example, 16 channels each having a distance of 2°. This is sufficient for recognizing obstacles.

The LIDAR module comprises a light source. The light source is adapted to emit pulses of light. The LIDAR module comprises an optical matrix. The optical matrix is adapted to direct the emitted pulses of light in accordance with a first scanning pattern. The optical matrix is, for example, electrically switchable so that emitted pulses of light pass through the optical matrix in defined directions. The emitted pulses of light which pass through the optical matrix illuminate a first field of view of the LIDAR module at a first scanning speed. Individual pixels of the matrix can be released through an LCD system with the optical matrix similarly to in the case of a television.

The advantage of the optical matrix is that the scanning pattern can be dynamically adapted. In addition, the optical matrix is less susceptible to vehicle vibrations, which has a positive effect on the service life of the LIDAR sensor.

Furthermore, the LIDAR module comprises a receiver. The receiver is adapted to detect the emitted pulses of light which are scattered by one or more distant objects. The receiver detects the scattered pulses of light. The receiver records a first image by means of the first scanning pattern of the detected pulses of light.

The LIDAR module scans the surroundings with a laser beam in quick succession and, as a result, obtains a three-dimensional image of the scanned spatial region. The transit time for each new laser beam position is measured with a certain resolution, as a result of which the distance of the LIDAR sensor of the LIDAR module from the scanned surface point of an object can be established. A distance value is thus assigned to each space pixel. The result is a three-dimensional image from the perspective of the LIDAR sensor.

Furthermore, the system comprises a camera module. The camera module records a second image of a second field of view. The second image is recorded by means of a second scanning pattern. The second image is recorded at a second scanning speed. The second field of view overlaps at least partially with the first field of view.

Images in the visible spectral range are, for example, captured with compact camera modules. CMOS image sensors which are also used in digital cameras are, for example, deployed as detectors.

The system further comprises a controller. The controller is coupled to the camera module and the LIDAR module for the transmission of signals. The controller is configured so that it adapts the first scanning pattern to the second scanning pattern. As a result, the first scanning pattern and the second scanning pattern are synchronized in time. The controller alternatively adapts the second scanning pattern to the first scanning pattern. The controller configures, for example, the optical matrix of the LIDAR module such that the emitted pulses of light pass through the optical matrix according to the first scanning pattern.

In this context, synchronized in time means that the first image and the second image are recorded at the same time. In this way, corresponding image regions, or individual pixels or pixel regions, from the overlapping fields of view can be more easily assigned to one another. Accordingly, the items of image information of the first image and the items of image information of the second image can be assigned to one another. An elaborate back-calculation of the items of image information assigned to one another is prevented or at least minimized. An item of overall image information can be generated from the obtained image information of the first image and of the second image.

Image information which is provided by the LIDAR module is, for example, distance information of the objects under consideration. Image information which is provided by the camera module is, for example, color and brightness information of the objects under consideration. The image information is, for example, provided in data packets for further evaluation. The overall image information of a data packet comprises, for example, distance information, color information and brightness information of an object under consideration or surroundings under consideration. Further image information can be added, if required, in order to extend the data packet. Further image information is, for example, speed information of the objects under consideration.

The first image and the second image, which have corresponding image information of first surroundings, are, for example, contained in a common first data packet. A first plurality of objects is, for example, arranged in the first surroundings.

The first image and the second image, which have corresponding image information of second surroundings, are contained in a common second data packet. A second plurality of objects is arranged, for example, in the second surroundings.

The first image and the second image, which have corresponding image information of further surroundings, are contained in a common further data packet. A further plurality of objects is arranged, for example, in the further surroundings. This also applies to each subsequent data packet.

The first sampling pattern and the second sampling pattern can remain unaltered for each data packet or can change jointly between two data packets.

According to one embodiment, the first field of view is imaged row by row by means of the first scanning pattern. The second field of view is imaged row by row by means of the second scanning pattern.

According to one embodiment, the first field of view is imaged column by column by means of the first scanning pattern. The second field of view is imaged column by column by means of the second scanning pattern.

According to one embodiment, the first image is recorded by means of the LIDAR module and the second image is recorded by means of the camera module with a defined time offset.

As a result, the first scanning pattern and the second scanning pattern are synchronized in time. In this context, synchronized in time means that the first image and the second image are recorded with a specified and defined time offset from one another. The order in which the first and second images are recorded can be changed. The defined time offset of the two images likewise makes easier assignment possible. Time-delayed first and second images are in each case contained in pairs in a corresponding data packet.

According to one embodiment, the second scanning speed of the camera module is adapted to the first scanning speed of the LIDAR module.

In order to compensate for different scanning speeds, for example, if the light source of the LIDAR module takes longer to scan than the camera module, the second scanning speed of the camera can be adapted to the first scanning speed. In particular, the second scanning speed can be slowed down.

The scanning speeds which have been adapted to one another can also be used with a specified and defined time offset between the first image and the second image.

According to one embodiment, the system comprises a second camera module. The second camera module records a third image of a third field of view by means of a third scanning pattern at a third scanning speed. The third field of view overlaps at least partially with the first field of view. The second field of view and the third field of view can have an overlap or can be not overlapping.

The use of two camera modules extends the second field of view by the third field of view and makes possible a larger overall field of view. The system is not restricted to one LIDAR module and two camera modules. For example, the system comprises a plurality of camera modules which are assigned to one or more LIDAR modules.

The controller is coupled to the first camera module, the second camera module and the LIDAR module for the transmission of signals. The controller is configured so that it adapts the third scanning pattern to the first scanning pattern or the first scanning pattern to the third scanning pattern. The first scanning pattern, the second scanning pattern and the third scanning pattern are adapted to one another.

For example, the first field of view is imaged row by row by means of the first scanning pattern. The second field of view is imaged row by row by means of the second scanning pattern. The third field of view is imaged row by row by means of the third scanning pattern. Alternatively, the first field of view is imaged column by column by means of the first scanning pattern. The second field of view is imaged column by column by means of the second scanning pattern. The third field of view is imaged column by column by means of the third scanning pattern.

The first scanning pattern and the third scanning pattern are synchronized in time. Alternatively, the first scanning pattern, the second scanning pattern and the third scanning pattern are synchronized in time.

For example, the first image, the second image and the third image can be recorded at the same time. In this way, corresponding image areas, or individual pixels or pixel regions, from the overlapping fields of view can be more easily assigned to one another. Accordingly, the image information of the first image, the image information of the second image, and the image information of the third image can be assigned to one another. Image information which is provided by the second camera module is, for example, color and brightness information of the objects under consideration. An elaborate back-calculating of the items of information assigned to one another is prevented or at least minimized. An item of overall image information can be generated from the obtained image information of the first image, the second image and the third image.

The third scanning speed of the second camera module is preferably adapted to the first scanning speed of the LIDAR module. In order to compensate for different scanning speeds, for example, if the light source of the LIDAR module takes longer to scan than the second camera module, the third scanning speed of the camera can be adapted to the first scanning speed. In particular, the third scanning speed can be slowed down.

According to one embodiment, the first image is recorded by means of the LIDAR module and the third image is recorded by means of the second camera module with a defined time offset.

As a result, the first scanning pattern and the third scanning pattern are synchronized in time. In this context, synchronized in time means that the first image and the third image are recorded with a specified and defined time offset from one another. The order in which the first and third images are recorded can be changed. The defined time offset of the two images likewise makes easier assignment possible. Time-delayed first and third images are in each case contained, in pairs, in a corresponding data packet.

Alternatively, the first image, the second image and the third image are recorded with a specified and defined time offset from one another. The order in which the first, second and third images are recorded can be changed. The defined time offset of the three images likewise makes easier assignment possible. The time-delayed first, second, and third images are in each case contained in a corresponding data packet.

Alternatively, the second image and the third image are recorded simultaneously and are recorded with an equal, defined time offset from the first image.

According to one embodiment, the first image and the second image have a spatial offset, which is evaluated by means of contiguous areas in the first image and in the second image, in order to determine a direction of movement and/or speed component of one or more objects.

The defined time offset of the first and second images results in a spatial offset of surroundings under consideration or an object under consideration.

The spatial offset is created by a relative movement between the moving vehicle which is equipped with the LIDAR module and the camera module, and a stationary object. The camera module records, for example, the second image at a first time, and the LIDAR module records the first image at a later second time. Alternatively, the LIDAR module records the first image at a first time, and the camera module records the second image at a later second time.

A first period of time, which corresponds to the time offset, elapses from the first point in time to the second point in time. The moving vehicle has covered a first measurement path during this elapsed period of time. The stationary object has not altered its position. The first measurement path is, for example, deduced on the basis of the speed of the moving vehicle. The same applies to a moving object and a stationary vehicle which is equipped with the LIDAR module and the camera module. The relative movement between the moving object and the stationary vehicle remains the same.

A standardized spatial offset which is standardized for the speed of the moving vehicle can be determined on the basis of the known time offset. The standardized spatial offset is always the same if the images have the same time offset.

It can be established whether an object remains stationary for any speed of the moving vehicle with the standardized spatial offset.

If the spatial offset of an object deviates from the standardized spatial offset, the object under consideration is a moving object. The degree to which the object is moving, or the speed thereof, can be established on the basis of the deviation of the observed spatial offset from the standardized spatial offset and the speed of the moving vehicle.

The objects under consideration are recognized, for example, on the basis of contiguous areas in the first image and in the second image. A pedestrian who is moving in the first and the second field of view, for example, forms a contiguous area. In a short period of time, the pedestrian moves so little that the time offset does not create two separate pedestrians. In terms of area, the pedestrian in the first image is related to the same pedestrian from the second image.

In this way, a direction of movement and a speed component of an object moving relative to the vehicle can be determined on the basis of a single first and second image. This has a positive effect on the computational power since fewer data packets are necessary, consequently making it possible for the system to consume less energy.

The defined time offset of the first and third images likewise results in a spatial offset of the surroundings under consideration or an object under consideration.

According to a further development, the system comprises a 3D radar. The 3D radar records a fourth image of a fourth field of view by means of a fourth scanning pattern at a fourth scanning speed. The fourth field of view overlaps at least partially with the first field of view. The fourth field of view can have an overlap, or can be not overlapping, with the second field of view and/or the third field of view.

Radar stands for radio direction and ranging. Radar devices which, in addition to the distance and the azimuth angle, also measure the elevation angle, and calculate the altitude therefrom, are referred to as three-dimensional or 3D radar. Radars can recognize objects, for example crossing vehicles, motorcycles, cyclists, and pedestrians. The 3D radar supplies additional image information. The relative movement between the vehicle and the object is determined from the received waves reflected by the object. The relative movement is calculated by the Doppler effect from the frequency shift of the reflected signal. The arrangement of individual measurements with the 3D radar after one another supplies the distance and the speed of the object under consideration.

The controller is coupled to the camera module, the LIDAR module, and the 3D radar for the transmission of signals. The controller can additionally be coupled to the second camera module for the transmission of signals. The controller can be coupled to a plurality of LIDAR modules, a plurality of camera modules, and one or more 3D radars for the transmission of signals.

The controller is configured so that it adapts the first scanning pattern to the fourth scanning pattern or the fourth scanning pattern to the first scanning pattern. The first scanning pattern, the second scanning pattern, the third scanning pattern, and the fourth scanning pattern are, for example, adapted to one another. The fourth scanning pattern can also be independent of the first scanning pattern. In particular, the 3D radar can also be used independently of the LIDAR module and the camera module.

The first scanning pattern and the fourth scanning pattern are, for example, synchronized in time. The first scanning pattern, the second scanning pattern, the third scanning pattern, and the fourth scanning pattern can be synchronized in time.

A vehicle is also provided which comprises the system for recognizing objects according to the embodiments.

Overall, driver assistance systems, such as the system for recognizing objects, have the potential to significantly increase vehicle safety and driver comfort. By providing real-time information, warnings, and assistance, these systems help to avoid accidents, minimize the severity of collisions, and reduce driver stress.

Features and configurations which apply to one LIDAR module and one camera module can also be transferred to all LIDAR modules and camera modules of the system. The embodiments and advantages are not limited to just a single LIDAR module and a single camera module.

### BRIEF DESCRIPTION OF THE DRAWINGS

Further advantages, features, and further developments are set out by the following examples which are explained in conjunction with the figures. Identical, similar or identically acting elements can be provided with the same reference numerals across the figures. The figures and the size ratios of the elements depicted in the figures are not to be regarded as being to scale. Rather, individual elements can be depicted on an exaggeratedly large/thick scale for greater ease of depiction and/or better comprehension, wherein:

FIGS. 1 to 3 show schematic representations of a system for recognizing objects according to exemplary embodiments,

FIGS. 4 to 6 show schematic representations of scanning patterns according to exemplary embodiments.

### DETAILED DESCRIPTION OF EXEMPLARY EMBODIMENTS

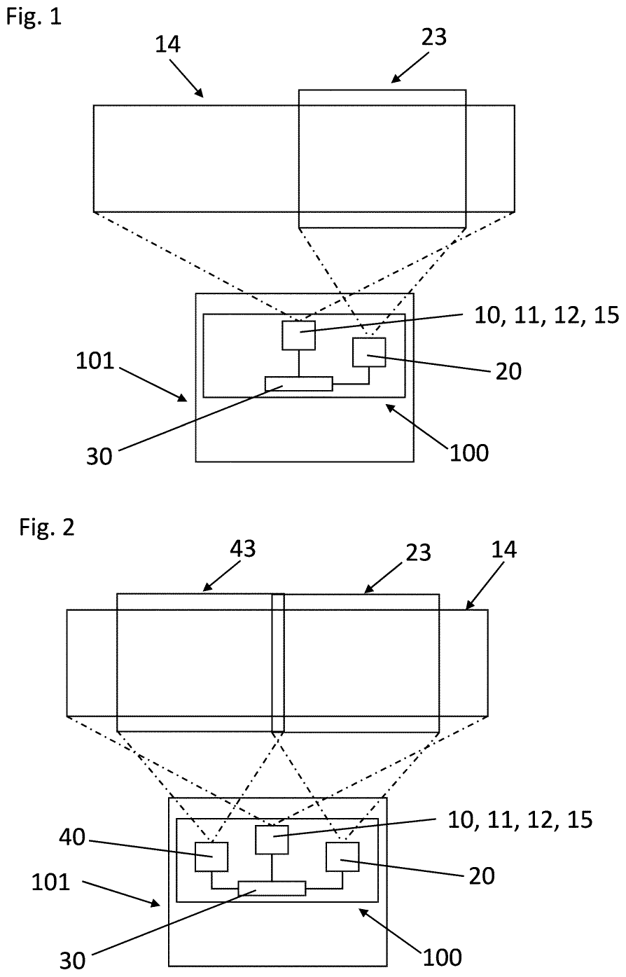

FIG. 1 shows a system 100 for recognizing objects for a vehicle 101. The system 100 is mounted on or in the vehicle 101. The system comprises a LIDAR module 10. The LIDAR module 10 is, for example, embodied as a compact sensor module. The LIDAR module 10 comprises a light source 11. The light source 11 is adapted to emit pulses of light. The LIDAR module 10 comprises an optical matrix 12.

The optical matrix 12 is electrically switchable, for example, so that emitted pulses of light pass through the optical matrix 12 in defined directions. The emitted pulses of light which pass through the optical matrix 12 illuminate a first field of view 14 of the LIDAR module 10 at a first scanning speed. With the optical matrix 12, individual pixels can be released, for example, through a liquid crystal display (also referred to as an LCD system) according to a defined pattern. The optical matrix 12 is less susceptible to vehicle vibrations than, for example, a rotating mirror, which has a positive effect on the service life of the LIDAR module 10. In the case of one possible design, the laser beam which is output by the light source 11 is deflected, for example, horizontally over a wide angular range, for example, up to 360°. In the vertical direction, a few angles are realized channel by channel, for example, 16 channels each having a 2° distance. This is sufficient for recognizing obstacles.

Furthermore, the LIDAR module 10 comprises a receiver 15. The receiver 15 is adapted to detect the emitted pulses of light, which are scattered by one or more distant objects in the first field of view 14. The receiver 15 detects the scattered pulses of light from the first field of view 14.

Furthermore, the system 100 comprises a camera module. 20. The camera module considers a second field of view 23. The second field of view 23 overlaps at least partially with the first field of view 14.

Images in the visible spectral range are, for example, captured with compact camera modules. CMOS image sensors which are also used in digital cameras are, for example, deployed as detectors.

The system 100 further comprises a controller 30. The controller 30 is coupled to the camera module 20 and the LIDAR module 10 for the transmission of signals. Any combination of the LIDAR module 10, the camera module 20, and the controller 30 can be accommodated in a single housing or can be realized in each case as separate assemblies.

FIG. 2 shows the system 100 for recognizing objects. FIG. 2 has the same construction of the system 100 as depicted in FIG. 1, with the difference that the system 100 comprises a second camera module 40. The second camera module 40 considers a third field of view 43 at a third scanning speed. The third field of view 43 overlaps at least partially with the first field of view 14. The second field of view 23 and the third field of view 43 have an overlap in FIG. 2. Alternatively, the second field of view 23 and the third field of view 43 do not overlap.

The use of the second camera module 40 extends the second field of view 23 by the third field of view 43 and makes possible a larger overall field of view. The system 100 is not restricted to a single LIDAR module 10 and two camera modules 20, 40. The system 100 comprises, for example, a plurality of camera modules which are assigned to one or more LIDAR modules.

The controller 30 is coupled to the first camera module 20, the second camera module 40, and the LIDAR module 10 for the transmission of signals.

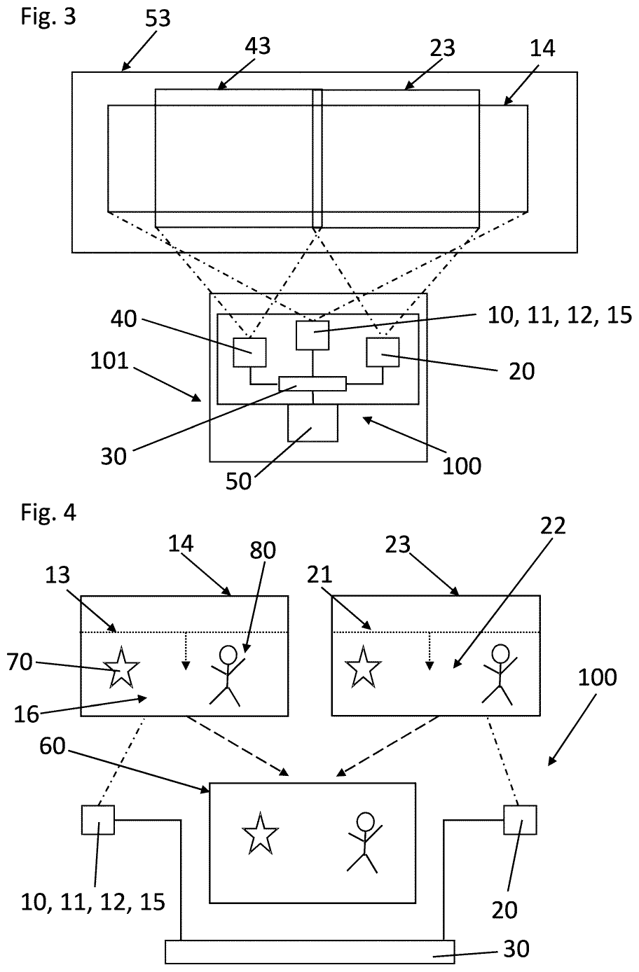

FIG. 3 shows a further embodiment of the system 100 for recognizing objects. FIG. 3 has the same construction of the system 100 as depicted in FIG. 2, with the difference that the system 100 comprises a 3D radar 50. The 3D radar considers a fourth field of view 53 at a fourth scanning speed. The fourth field of view 53 overlaps at least partially with the first field of view 14. The fourth field of view 53, the second field of view 23, and the third field of view 43 have an overlap in FIG. 3. Alternatively, the fourth field of view 53 overlaps with a combination of the first field of view 14, the second field of view 23, and the third field of view 43. The fourth field of view 53 can have an overlap with the second field of view 23 and/or the third field of view 43 or can also be designed to not be overlapping.

Radar stands for radio direction and ranging. In addition to the distance and the azimuth angle, the elevation angle can also be measured with the 3D radar 50. The altitude is calculated from this. The 3D radar 50 can recognize objects, for example, crossing vehicles, motorcycles, cyclists, and pedestrians. The 3D radar supplies additional image information to the image information of the LIDAR module 10 and the camera module 20 and/or the second camera module 40. Alternatively, the system 100 only comprises the LIDAR module 10, the camera module 20, the 3D radar 50, and the controller 30.

The controller is coupled to the camera module 20, the LIDAR module 10, and the 3D radar 50 for the transmission of signals. The controller can additionally be coupled to the second camera module 40 for the transmission of signals. The controller 30 can be coupled to a plurality of LIDAR modules, a plurality of camera modules, and one or more 3D radars for the transmission of signals. The 3D radar 50 can also be used independently of the LIDAR module 10 and the camera module 20.

The relative movement between the vehicle and the object is determined from the received waves reflected by the object. The relative movement is calculated by the Doppler effect from the frequency shift of the reflected signal. The arrangement of individual measurements with the 3D radar after one another supplies the distance and speed of the object under consideration.

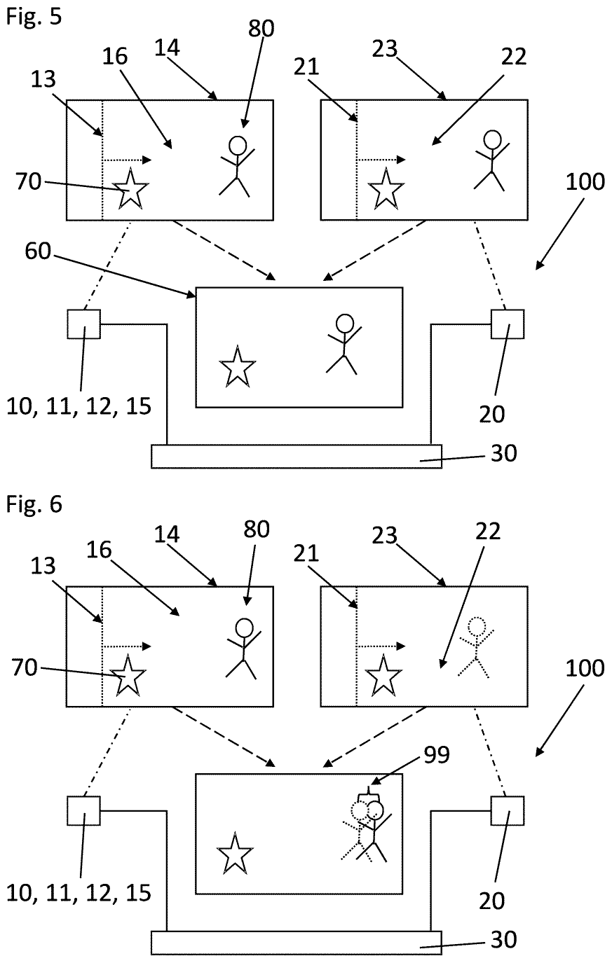

FIG. 4 and FIG. 5 show embodiments of a first scanning pattern 13 and of a second scanning pattern 21. The fields of view 14, 23 are not depicted overlapping in FIG. 4 and FIG. 5, for the sake of clarity. In application, the LIDAR module 10 and the camera module 20 overlap at least partially. The LIDAR module 10 and the camera module 20 are coupled to the controller 30 for the transmission of signals.

The optical matrix 12 is adapted to direct the pulses of light emitted by the light source 11 in accordance with a first scanning pattern 13. The advantage of the optical matrix 12 is that scanning patterns of the LIDAR module 10 can be dynamically adapted.

The emitted pulses of light are scattered by an object in the first field of view 14 and can be detected by the receiver 15 of the LIDAR module 10. The receiver 15 records a first image 16 of the first field of view 14 by means of the detected pulses of light. The first image 14 is recorded at a first scanning speed.

The camera module 20 records a second image 22 of the second field of view 23. The second image 22 is recorded by means of a second scanning pattern 24. The second image 22 is recorded at a second scanning speed.

The controller 30 is configured so that it adapts the first scanning pattern 13 to the second scanning pattern 24. As a result, the first scanning pattern 13 and the second scanning pattern 24 are synchronized in time. The controller 30 alternatively adapts the second scanning pattern 24 to the first scanning pattern 13. The controller 30 configures, for example, the optical matrix 12 of the LIDAR module 10 such that the emitted pulses of light pass through the optical matrix according to the first scanning pattern 13.

Furthermore, the controller is configured so that it adapts scanning patterns of various modules and sensors to the first scanning pattern, or it adapts the first scanning pattern to scanning patterns of various modules and sensors. For the sake of clarity, only the LIDAR module 10 and the camera module 20 are depicted in FIGS. 4 and 5.

The first field of view 14 is imaged row by row by means of the first scanning pattern 13 in FIG. 4. The second field of view 23 is likewise imaged row by row by means of the second scanning pattern 24.

In FIG. 5, in contrast to FIG. 4, the first field of view 14 is imaged column by column by means of the first scanning pattern 13. The second field of view 23 is likewise imaged column by column by means of the second scanning pattern 24.

The images 16, 22 of the LIDAR module 10 and the camera module 20 can be correctly assigned in time thanks to the synchronized, identical scanning patterns 13, 24. This is particularly advantageous in inner-city traffic, since a vehicle equipped with the system 100 frequently acquires many images when turning. Even objects which enter the field of view from a lateral side can be interpreted with at least fewer errors. In this way, image information does not have to be back-calculated or at least has to be calculated with less computational power. The first scanning pattern 13 and the second scanning pattern 24 can remain unaltered for each data packet or can change jointly between two data packets.

Possible misinterpretations can be compensated for by synchronizing the recording time of the camera module 20 and the LIDAR module 10.

In the case of a plurality of camera modules, LIDAR modules, and 3D radars which are mounted on a vehicle, the actuation times of the individual modules can also be synchronized so that consistency is achieved not only in pairs, but for the entire environment.

In this context, synchronized in time means that the first image 16 and the second image 22 are recorded at the same time. In this way, corresponding image regions, or individual pixels or pixel regions, from the overlapping fields of view 14, 23 can be more easily assigned to one another. Accordingly, the items of image information of the first image 16 and the items of image information of the second image 22 can be assigned to one another. An elaborate back-calculation of the items of image information assigned to one another is prevented or at least minimized. An item of overall image information can be generated from the obtained image information of the first image 16 and of the second image 22.

Image information which is provided by the LIDAR module 10 is, for example, distance information of the objects under consideration. Image information which is provided by the camera module 20 is, for example, color and brightness information of the objects under consideration. The image information is provided, for example, in data packets 60 for further evaluation. The overall image information of a data packet 60 comprises, for example, distance information, color information and brightness information of an object under consideration or surroundings under consideration. Further image information can be added, if required, in order to extend the data packet 60. Further image information is, for example, speed information of the objects under consideration in the first field of view 14 and/or in the second field of view 23.

For example, the first image 16 and the second image 22, which have corresponding image information of first surroundings, are contained in a common first data packet 60. A first plurality of objects is arranged, for example, in the first surroundings.

The first image 16 and the second image 22, which have corresponding image information of further surroundings, are contained in a common further data packet. A further plurality of objects is, for example, arranged in the further surroundings. This also applies to each subsequent data packet.

A stationary object 70 is depicted as a star in the first field of view 14. This does not constitute a restriction and can refer to any stationary object 70. For example, stationary objects 70 are parked vehicles, pedestrians standing still, buildings, traffic lights, road signs, or similar. This does not constitute an exhaustive list.

A moving object 80 is embodied, for example, as a stick figure in the first field of view 14. This does not represent a restriction and can refer to any moving object 80 and is not limited to living beings. For example, moving objects 80 are moving vehicles, moving pedestrians, or similar. This does not constitute an exhaustive list.

The first image 16 and the second image 22 are recorded simultaneously. Accordingly, the stationary object 70 is likewise depicted as a star in the second field of view 23. The moving object 80 is embodied, for example, as a stick figure in the second field of view 23.

This does not constitute a restriction and can refer to any stationary object 70 and moving object 80. For example, stationary objects 70 are parked vehicles, pedestrians standing still, buildings, traffic lights, road signs, or similar. For example, moving objects 80 are moving vehicles, moving pedestrians, or similar. This does not constitute an exhaustive list.

FIG. 6 shows a further embodiment of a first scanning pattern 13 and of a second scanning pattern 21. The first image 16 and the second image 22 are recorded in a time-delayed manner.

The defined time offset of the first and second images 16, 22 results in a spatial offset 99 of surroundings under consideration or an object under consideration. The moving object 80 in the form of the stick figure moves, for example, from the first image 16 to the second image 22 in FIG. 6.

The spatial offset 99 can also be created by a relative movement between the moving vehicle which is equipped with the LIDAR module 10 and the camera module 20, and a stationary object 70. For example, the camera module 20 records the second image 22 at a first point in time, and the LIDAR module 10 records the first image 16 at a later second point in time. Alternatively, the LIDAR module 10 records the first image 16 at a first point in time, and the camera module 20 records the second image 22 at a later second point in time.

On the basis of the known time offset, a standardized spatial offset can be determined, which is standardized for the speed of the moving vehicle. The standardized spatial offset is always the same if the time offset of the images 16, 22 is the same. It can be established whether an object remains stationary for any speed of the moving vehicle with the standardized spatial offset. For the sake of clarity, FIG. 6 considers the situation in which the LIDAR module 10 and the camera module 20 are not moving. If the LIDAR module 10 and the camera module 20 were moving, further projections of the stationary objects 70 and moving objects 80 would be added. Each object would therefore have a further duplicate.

A first period of time, which corresponds to the time offset, elapses from the first point in time to the second point in time. The moving vehicle has covered a first measurement path during this elapsed period of time. The stationary object has not altered its position. The first measurement path is, for example, deduced on the basis of the speed of the moving vehicle. The same applies to a moving object and a stationary vehicle which is equipped with the LIDAR module and the camera module. The relative movement between the moving object and the stationary vehicle remains the same.

If the spatial offset 99 of an object deviates from the standardized spatial offset, the object under consideration is a moving object 80. The degree to which the object is moving, or the speed thereof, can be established on the basis of the deviation of the observed spatial offset 99 from the standardized spatial offset and the speed of the moving vehicle.

The objects under consideration are recognized, for example, on the basis of contiguous areas in the first image 16 and the second image 22. For example, the head of a pedestrian who is moving in the first field of view 14 and the second field of view 23 forms a contiguous area. In a short period of time, the pedestrian 80 moves so little that the time offset does not create two separate pedestrians 80. In terms of area, the pedestrian in the first image 16 is related to the same pedestrian from the second image 23. This is depicted by a dashed stick figure and a stick figure with a solid line in the data packet 60.

In this way, a direction of movement and a speed component of an object 80 moving relative to the vehicle can be determined on the basis of a single first and second image 16, 22. This has a positive effect on the computational power since fewer data packets are necessary, consequently making it possible for the system 100 to consume less energy.

The first field of view 14 is imaged column by column by means of the first scanning pattern 13 and the second field of view 23 is imaged column by column by means of the second scanning pattern 21 in FIG. 6. Alternatively, the first field of view 14 is imaged row by row by means of the first scanning pattern 13 and the second field of view 23 is imaged row by row by means of the second scanning pattern 21.

### LIST OF REFERENCE NUMERALS

100 System
10 LIDAR module
11 Light source
12 Optical matrix
13 First scanning pattern
14 First field of view
15 Receiver
16 First image
20 Camera module
21 Second scanning pattern
22 Second image
23 Second field of view
30 Controller
40 Second camera module
41 Third scanning pattern
42 Third image
43 Third field of view
50 3D radar
51 Fourth scanning pattern
52 Fourth image
53 Fourth field of view
60 First data packet
70 Stationary object
80 Moving object
99 Spatial offset

1. A system for recognizing objects for a vehicle, comprising
a LIDAR module comprising
a light source which is adapted to emit pulses of light,
an optical matrix which is adapted to direct the emitted pulses of light in accordance with a first scanning pattern in order to illuminate a first field of view of the LIDAR module at a first scanning speed,
a receiver which is adapted to detect the emitted pulses of light which are scattered by one or more distant objects in order to record a first image by the first scanning pattern,
a camera module which records a second image of a second field of view by a second scanning pattern at a second scanning speed, wherein the second field of view overlaps at least partially with the first field of view,
a controller which is coupled to the camera module and the LIDAR module for the transmission of signals, wherein the controller is configured so that it adapts the first scanning pattern to the second scanning pattern or the second scanning pattern to the first scanning pattern in order to synchronize the first scanning pattern and the second scanning pattern in time.

2. The system according to claim 1, wherein the first field of view is imaged row by row by the first scanning pattern, and wherein the second field of view is imaged row by row by means of the second scanning pattern.

3. The system according to claim 1, wherein the first field of view is imaged column by column by the first scanning pattern, and wherein the second field of view is imaged column by column by means of the second scanning pattern.

4. The system according claim 1, wherein the first image is recorded by the LIDAR module and the second image is recorded by means of the camera module with a defined time offset.

5. The system according to claim 1, wherein the second scanning speed of the camera module is adapted to the first scanning speed of the LIDAR module.

6. The system according to claim 1, comprising a second camera module, which records a third image of a third field of view by a third scanning pattern at a third scanning speed, wherein the third field of view overlaps at least partially with the first field of view, wherein the controller is configured so that it adapts the first scanning pattern to the third scanning pattern or the third scanning pattern to the first scanning pattern in order to synchronize the first scanning pattern, the second scanning pattern and the third scanning pattern in time.

7. The system (according to claim 6, wherein the first image is recorded by the LIDAR module and the third image is recorded by the second camera module with a defined time offset.

8. The system according to claim 1, wherein the first image and the second image have a spatial offset which is evaluated by contiguous areas in the first image and in the second image in order to determine a direction of movement and/or speed component of one or more objects.

9. The system according to claim 1, comprising a 3D radar which records a fourth image of a fourth field of view by a fourth scanning pattern at a fourth scanning speed, wherein the fourth field of view overlaps at least partially with the first field of view, and wherein the controller is coupled to the camera module, the LIDAR module and the 3D radar for the transmission of signals.

10. A vehicle comprising a system according to claim 1.
